(19) United States
(12) Patent Application Publication
(10) Pub. No.: US 2010/0299396 A1
(43) Pub. Date: Nov. 25, 2010

(54) METHOD AND SYSTEM FOR CONFIGURING A SELECTION STATUS FOR CONTACTS CONTAINED IN AN ELECTRONIC ADDRESS BOOK

(75) Inventors: Adil Memon, Welwyn Garden City (GB); Naveed Anis Khawaja, Welwyn Garden City (GB); Maliha Naveed, Welwyn Garden City (GB)

Correspondence Address: ORTIZ & LOPEZ, PLLC, P.O. Box 4484, Albuquerque, NM, 87196-4484, US

(73) Assignee: Xerox Corporation

(21) Appl. No.: 12/471,031

(22) Filed: May 22, 2009

(51) Int. Cl. G06F 15/16; G06F 3/048

(52) U.S. Cl. 709/206; 715/823

(57) ABSTRACT

A method and system for configuring a selection status with respect to one or more contact items in an e-mail address book is disclosed. The e-mail address book related to an e-mail editor includes the contact items from which a list of intended e-mail recipients can be selected for e-mailing via a number of actions (e.g., “To:”, “Cc:”, or “Bcc:”). A status indicator can be utilized to indicate actions applicable to each of the contact items in a current work flow. The status indicator can be displayed alongside each contact item from the address book that permits a user to easily identify the selection status related to the contact items at a glance when scrolling through the list of intended recipients.

### TECHNICAL FIELD

Embodiments are generally related to data-processing systems and methods. Embodiments are also related to multifunction devices such as printers, scanners, photocopy machines, and the like. Embodiments are additionally related to methods and systems for managing e-mail addresses.

### BACKGROUND OF THE INVENTION

Electronic mail (or e-mail) generally provides an efficient and timely form of communication for individuals, enterprises, and other organizations. Multi-function devices such as, for example, printers and scanners, are typically connected to data networks such as the Internet and can exchange both image data and associated operational instructions. A “scan-to-e-mail” function associated with such a multi-function device can provide an option for scanning an original document and creating an electronic image file and e-mailing of the generated electronic image file. Such a “scan-to-e-mail” function generally enables a user to utilize a personal computer connected to the multi-function device via a data network in order to execute an e-mail editor. The “scan-to-e-mail” function can also be utilized to e-mail a previously stored electronic image file. The electronic image file from a memory of the multi-function device can be accessed and imported into the e-mail editor for transmitting the file as an attachment to an e-mail message composed by the e-mail editor.

The message and the attachment can be transmitted to one or more recipients from an address book of the e-mail editor. The contacts from the address book can be selected for sending the e-mail through “To:”, “Cc:” and “Bcc:” recipient fields. The majority of prior art “scan-to-e-mail” functions do not provide status information regarding the selection status of the contacts in a contact list for an intended action. A user must compare the selected list with the actual contact list in order to obtain information regarding the status of the contacts. Such an approach is time consuming. Additionally, prior art e-mail editors do not provide information regarding the actions applied to the contacts.

Based on the foregoing, it is believed that a need exists for an improved method and system for configuring selection status for the contacts in an electronic address book, as described in greater detail herein.

### BRIEF SUMMARY

The following summary is provided to facilitate an understanding of some of the innovative features unique to the present invention and is not intended to be a full description. A full appreciation of the various aspects of the embodiments disclosed herein can be gained by taking the entire specification, claims, drawings, and abstract as a whole.

It is, therefore, one aspect of the present invention to provide for an improved data-processing method, system, and computer-usable medium.

It is another aspect of the present invention to provide for a method, system, and computer-usable medium for configuring a selection status for contacts in an e-mail address book.

It is a further aspect of the present invention to provide for a method, system, and computer-usable medium for providing a status indicator with respect to the contacts included in an address book.

The aforementioned aspects and other objectives and advantages can now be achieved as described herein. A method and system for configuring the selection status of one or more contact items in an electronic address book is disclosed. The electronic address book is associated with an e-mail editor and includes contact items from which a list of intended e-mail recipients can be selected for e-mailing via any one of a number of possible e-mail actions (e.g., “To:”, “Cc:”, or “Bcc:”). A status indicator can be configured to indicate the actions applicable to each of the contact items in a current work flow. The status indicator can be graphically displayed alongside each contact item from the electronic address book in order to permit a user to easily identify, at a glance, the selection status related to the contact items when scrolling through a list of intended e-mail recipients.

The status indicator indicates the action applied to each contact item, which in turn can be stored and updated in association with the e-mail address of the contact item at a server. The proposed approach provides an option that permits a user to easily identify if a contact has already been selected for the intended action (e.g., To, Cc, or Bcc). The disclosed embodiments may be implemented in association with a multifunction device having a “scan-to-e-mail” function in order to provide the selection status for the contact items in the electronic address book.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic view of a computer system in which the present invention may be embodied;

FIG. 2 illustrates a schematic view of a software system including an operating system, application software, and a user interface for carrying out the present invention;

FIG. 3 illustrates a block diagram of a network of data-processing systems in association with an e-mail server and a multi-function device in which aspects of the present invention may be implemented;

FlG. 4 illustrates a GUI of an address book associated with a list of contact items, in accordance with an embodiment;

FIG. 5 illustrates a GUI of an e-mail editor associated with the address book, in accordance with an embodiment; and

FIG. 6 illustrates a high level flow chart of operation illustrating a method for configuring a status indicator for contact items in the address book, in accordance with an embodiment.

### DETAILED DESCRIPTION

The particular values and configurations discussed in these non-limiting examples can be varied and are cited merely to illustrate at least one embodiment and are not intended to limit the scope thereof.

The disclosed embodiments provide the capability of configuring a status indicator in association with one or more contact items within an electronic address book in order to indicate actions applicable to each recipient in a current work flow. Utilizing the embodiments described herein, a selection status for one or more contact items contained in the electronic address book can be identified.

Various computing environments may incorporate capabilities for supporting an e-mail network to which one or more scanning or other rendering devices may reside. The following discussion is intended to provide a brief and general description of suitable computing environments in which the disclosed embodiments may be implemented. Although not required, the disclosed embodiments will be described in the general context of computer-executable instructions such as program modules that are capable of being executed by one or more computers. Generally, program modules include routines, programs, objects, components, data structures, etc., that perform particular tasks or implement particular abstract data types. Moreover, those skilled in the art will appreciate that the disclosed embodiments may be practiced with other computer system configurations including hand-held devices, multi-processor systems, microprocessor-based or programmable consumer electronics, networked PCs, minicomputers, mainframe computers, and the like.

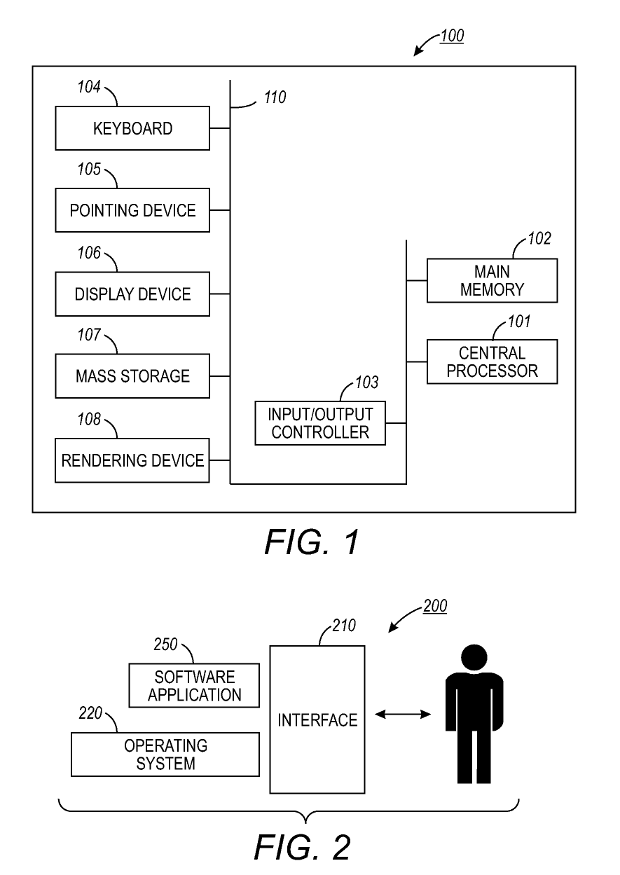

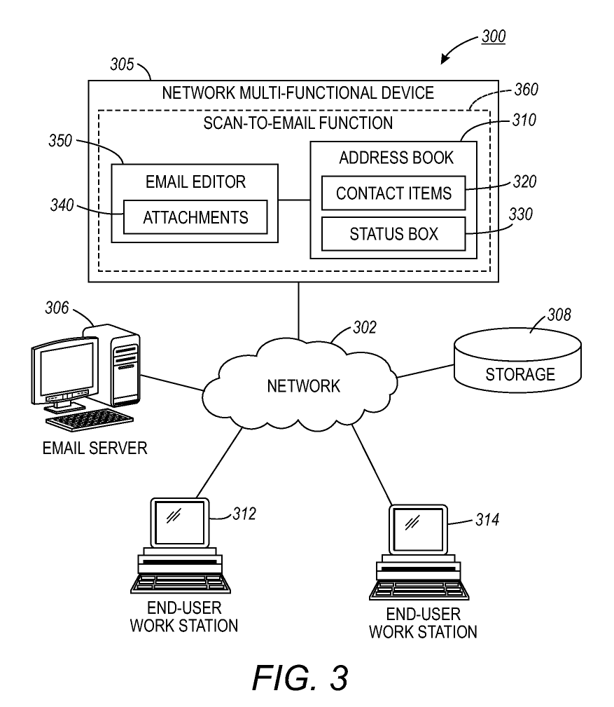

FIGS. 1-2 are provided as exemplary diagrams of data processing environments in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

As depicted in FIG. 1, the present invention may be embodied in the context of a data-processing apparatus 100 comprising a central processor 101, a main memory 102, an input/output controller 103, a keyboard 104, a pointing device 105 (e.g., mouse, track ball, pen device, or the like), a display device 106, and a mass storage 107 (e.g., hard disk). Additional input/output devices, such as a rendering device 108, may be included in the data-processing apparatus 100 as desired. The rendering device 108 may be a standalone single function device such as a dedicated printer, scanner, copy machine, etc. Preferably, rendering device 108 functions as a multifunction device capable of multiple rendering functions such as printing, copying, scanning, faxing, etc. As illustrated, the various components of the data-processing apparatus 100 communicate through a system bus 110 or similar architecture.

A computer software system 200 for directing the operation of the data-processing apparatus 100 is depicted in FIG. 2. Software application 250, which is stored in main memory 102 and on mass storage 107, can include a kernel or operating system 220 and a shell or interface 210. One or more application programs such as application software 250, may be “loaded” (i.e., transferred from mass storage 107 into the main memory 102) for execution by the data-processing apparatus 100. The data-processing apparatus 100 thus can receive user commands and data through user interface 210; these inputs may then be acted upon by the data-processing apparatus 100 in accordance with instructions from operating module 220 and/or application module 250.

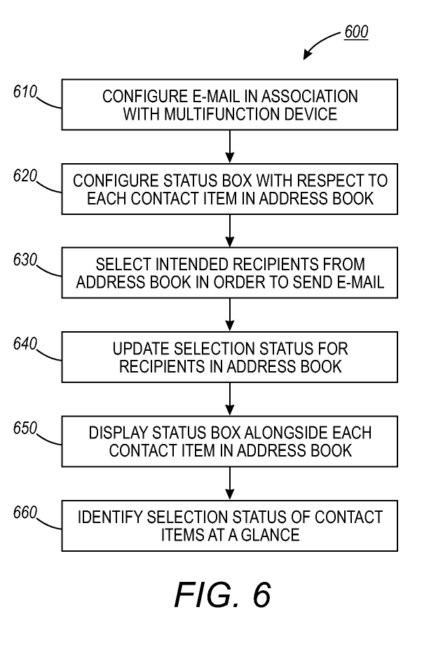

The interface 210, which is preferably a graphical user interface (GUI), also serves to graphically display results, whereupon a user may supply additional inputs or terminate a particular session. In one particular embodiment, operating system 220 and interface 210 can be implemented in the context of a “Windows” system. Application module 250, on the other hand, can include instructions such as the various operations described herein with respect to the various components and modules described herein such as, for example, the method 600 depicted in FIG. 6.

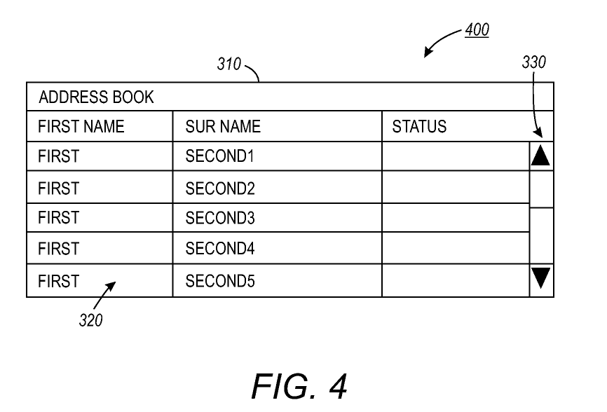

FIG. 3 illustrates a block diagram of a network of data-processing systems 300 in association with an e-mail server 306 and a multifunction device 305 in which aspects of the present invention may be implemented. Note that the multifunction device 305 is analogous to the rendering device 108 discussed earlier. The embodiments described herein provide the capability of selecting a group of e-mail addresses and compiling the selected e-mail address in the context of a distribution list accessible through a user interface associated with the multi-function device 305. The multi-function device 305 generally includes a “scan-to-e-mail” function 360 residing on a computer network 302 in association with a storage device 308. The network 302 may include one or more end-user work stations 312 and 314 and an e-mail server 306 capable of sending and receiving e-mail messages through the network 302. It is assumed that the network 302 includes an Internet gateway (not shown in FIG. 3).

The end-user work stations 312 and 314 may be, for example, personal computers or networked computers. The end-user work stations 312 and 314 may be devices such as, for example, the data-processing apparatus 100 of FIG. 1. The e-mail server 306 can be configured as an e-mail server that receives and routes e-mails from one or more users through the network 302. The e-mail server 306 can utilize various standard e-mail protocols and network connections (e.g., SMTP (Simple Mail Transfer Protocol) over TCP/IP (Transmission Control Protocol/Internet Protocol)) to perform its e-mail transmission service.

In the depicted example shown in FIG. 3, network data processing system 300 is the Internet with network 302 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational, and other computer systems that route data and messages. Of course, network data processing system 300 also may be implemented as a number of different types of networks such as for example, an intranet, a local area network (LAN), or a wide area network (WAN). FIG. 3 is intended as an example and not as an architectural limitation for different embodiments of the present invention.

The following description is presented with respect to embodiments of the present invention, which can be embodied in the context of a data-processing system such as data-processing apparatus 100, computer software system 200, and data-processing system 300 and network 302 depicted respectively FIGS. 1-3. The present invention, however, is not limited to any particular application or any particular environment. Instead, those skilled in the art will find that the system and methods of the present invention may be advantageously applied to a variety of system and application software, including database management systems, word processors, and the like. Moreover, the present invention may be embodied on a variety of different platforms, including Macintosh, UNIX, LINUX, and the like. Therefore, the description of the exemplary embodiments, which follows, is for purposes of illustration and not considered a limitation.

The multi-function device 305 is capable of scanning image material and is equipped with the “scan-to-e-mail” function 360, which permits users of the device 305 to select e-mail addresses from a local electronic address book 310 or key in e-mail addresses and transmit scanned images to the intended recipients. The scanned images may be in various formats, for example, PDF (portable document format), TIFF (tag image file format), JPEG (joint photo graphics experts group format), GIF (graphics interchange format), or BMP (Bitmap). In addition to scanning and transmitting the scanned image via e-mail, the multi-function device 305 may also include functionality for printing, copying, or transmitting facsimile images, etc.

The electronic image file from the multi-function device 305 can be accessed and imported into an e-mail editor 350 for transmitting the file as an attachment 340 to an e-mail message composed by the e-mail editor 350. The e-mail editor 350 can further transfer the attachment 340 to a list of intended e-mail recipients within the electronic address book 310. The electronic address book 310 associated with the e-mail editor 350 includes the contact items 320 from which the list of intended e-mail recipients can be selected for e-mailing. Operations of the multi-function device 305 can be controlled from a user interface, which enables a user to select the function to be performed as well as enter information required by the device to perform an operation. Typically buttons or a keypad are utilized to enter information and select functionality, but a touch screen or any other means known in the art may be utilized. The “scan-to-e-mail” capability 360 also permits the user to amend the title of the e-mail message and to compose a message to be transmitted with the scanned image. The e-mail server 306 receives the scanned image with e-mail transmission instructions from the multi-function device 305 and forwards the messages to the network 302, which further forwards it to the end user work stations 312 and 314.

FIG. 4 illustrates a GUI 400 of the electronic address book 310 associated with the list of contact items 320, in accordance with an embodiment. Note that in FIGS. 1-6, identical or similar blocks are generally indicated by identical reference numerals. In general, the electronic address book 310 can be configured in the context of a database for storing e-mail addresses and other associated contact information. The electronic address book 310 of e-mail client provides a database of stored e-mail addresses and other addressing information. It will be understood that any type of database structure may be utilized by the electronic address book 310 to sort and store e-mail addresses. The list of intended recipients from the electronic address book 310 can be selected by a number of options such as, for example, “To:”, “Cc:”, or “Bcc:” options provided in the e-mail editor 350. Each contact item 320 associated with the electronic address book 310 can be provided with a status indicator 330 that indicates actions applied such as, for example, “To:”, “Cc:”, or “Bcc:” to each of the recipients in a current work flow. Note that the status indicator can be presented in some embodiments as a graphically displayed “status box”. The status indicator 330 provides selection status applied to the contact items 320 at a glance to the user by avoiding manual comparisons of the intended recipient list with actual contact items 320.

The status indicator 330 that appears next to each of the contact items 320 in the electronic address book 310 permits a user to easily identify the actions (e.g., “To:”, “Cc:”, or “Bcc:”) applied to the contact items 320 in the electronic address book 310 at a glance when scrolling the list of intended recipients. The status indicator 330 provides an easy option to identify whether a contact has already been selected for the intended action. Note that the embodiments discussed herein should not be construed in any limited sense. It can be appreciated that such embodiments reveal details of the structure of a preferred form necessary for a better understanding of the invention and may be subject to change by skilled persons within the scope of the invention without departing from the concept thereof.

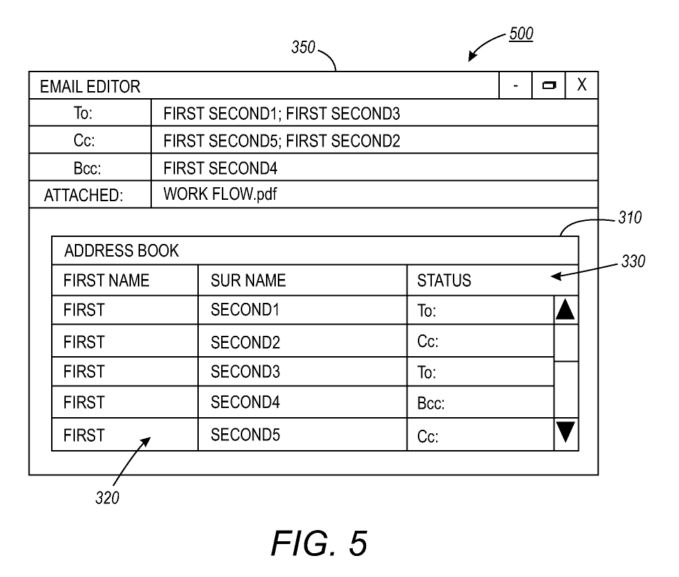

FIG. 5 illustrates a GUI 500 associated with the e-mail editor 350 and the electronic address book 310, in accordance with an embodiment. The e-mail editor 350 can be utilized to create custom e-mail messages by providing image data as an attachment 340. The e-mail messages can be utilized in large scale e-mail campaigns, for example, in which the e-mail messages are transmitted to a list of intended recipients from the contact item list 320 associated with the electronic address book 310. The e-mail editor 350 can provide an interface to a user of the data processing apparatus 100, for example, through a standard web browser. The e-mail editor 350 permits a user to edit the content and layout of the e-mail message and display a representation of the e-mail message in such a manner that the user may customize the content and layout of the e-mail message.

As illustrated in FIG. 5, the e-mail editor 350 can be initially uploaded with the attachment, for example workflow.pdf. A list of recipients such as FirstSecond1 and FirstSecond3 and so forth can be assigned to the “To:” option of the e-mail editor 350. Further, FirstSecond2 and FirstSecond5 may be assigned to the “Cc:” option of the e-mail editor 350. Additionally, FirstSecond4 may be assigned to the “Bcc:” option of the e-mail editor 350. The selection status can be configured for each of the recipients selected in the e-mail editor 350. The status indicator 330 for the contact items FirstSecond1 and FirstSecond3 indicates a “To:” option, while the status indicator 330 for the contact items FirstSecond2 and FirstSecond5 indicates a “Cc:” option. Finally, the status indicator 330 for the contact items FirstSecond4 indicates a “Bcc:” option. Thus, in this particular scenario, a user can identify at a glance, the actions applicable to each of the contact item(s) 320 of the electronic address book 310, while avoiding repetitive comparisons of the recipient list with the actual contact items.

FIG. 6 illustrates a high level flow chart of operation illustrating a method 600 for configuring the selection status for the contact items 320 associated with the electronic address book 310, in accordance with an embodiment. As indicated in the example methodology depicted in FIG. 6, the e-mail editor 350 can be configured in association with the multi-function device 305, as depicted at block 610. Next, as illustrated at block 620, the status indicator 330 can be configured with respect to each contact item 320. The e-mail editor 350 is capable of receiving the attachment(s) 340 to be e-mailed from the multi-function device 305. The attachment(s) 340 may be, for example, electronic image files of scanned documents or text messages. The list of intended recipients from the contact items 320 associated with the electronic address book 310 can be selected (e.g., via “To:”, “Cc:”, or “Bcc:”) in order to send the e-mail, as depicted at block 630. Thereafter, as illustrated at block 640, the selection status for each of the recipients in the electronic address book 310 can be updated.

The status indicator 330 can be graphically displayed alongside each contact item 320 in the electronic address book 310, as indicated at block 650. The user may utilize the status indicator 330 to identify at a glance the actions applicable to the contact items 320, as illustrated at block 660. The e-mail can be transferred to the e-mail server 306 via the network 302. The e-mail server 306 can receive electronic data from the multi-function device 305 and route the electronic data to the intended recipients designated by the originator. The e-mail server 306 may either deliver the electronic data directly to the recipient or to intervening servers that deliver the electronic data to the recipients. The e-mail server 306 can be implemented as a computer that directs messages to an appropriate place/location. When an e-mail is sent using client software, it is sent to the server which then processes it and sends it to the appropriate party. The e-mail sever 306 may also constitute, in some embodiments, a software program/module that runs on a server that is constantly connected to the Internet. Unlike an e-mail client, the e-mail server 306 is generally responsible for transporting the e-mail from a sender to a recipient's e-mail server. E-mail server 306 is also capable of storing e-mail data prior to delivery.

Note that the methodology disclosed herein (e.g., method 600) can be implemented in the context of a computer-useable medium that contains a program product. Such a methodology or approach may also be implemented in a computer-usable medium containing a program product. Programs defining particular functions/instructions such as those depicted in the accompany figures can be delivered to a data storage system or a computer system via a variety of signal-bearing media, which include, without limitation, non-writable storage media (e.g., CD-ROM), writable storage media (e.g., hard disk drive, read/write CD ROM, optical media), system memory such as, but not limited to, Random Access Memory (RAM), and communication media such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having components in the form of hardware, software, or a combination of software and hardware as described herein or their equivalent.

While the present invention has been particularly shown and described with reference to an embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

The disclosed embodiments for configuring the selection status for contact items in the electronic address book can improve the customer experience when scrolling through the list of intended e-mail recipients by providing the user an easy option to identify whether a contact has already been selected for the intended purpose (e.g., To, Cc, or Bcc). The disclosed embodiments for configuring the selection status can be effectively utilized in various web-portals and desktop applications.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A method for configuring a selection status for contacts, said method comprising:
generating a status indicator with respect to at least one contact item associated with an electronic address book, in order to indicate an action applicable to at least one contact item; and
graphically displaying said status indicator with respect to a selection status of said contact item and in association with said at least one contact item, wherein said status indicator indicates an identification of said selection status of at least one intended e-mail recipient.

2. The method of claim 1 further comprising configuring said electronic address book with respect to an email editor wherein said electronic address book includes said at least one contact item from which said at least one intended email recipient is selected for emailing an attachment associated with said email editor.

3. The method of claim 1 further comprising configuring said status indicator to provide an option that identifies whether said at least one contact item was previously selected for an intended action.

4. The method of claim 1 wherein said at least one intended email recipient is selected from said electronic address book via at least one of the following actions: a “To:” action, a “Cc:” action, and a “Bcc:” action.

5. The method of claim 1 further comprising updating said action applicable to said at least one intended email recipient in association with an email address associated with said at least one contact item.

6. The method of claim 1 further comprising associating said status indicator with an electronic address book in a context of a scan-to-email functionality.

7. The method of claim 2 wherein said attachment comprises image data generated by a multi-function device.

8. The method of claim 2 wherein said attachment comprises a text message.

9. A system for configuring a selection status for contacts, said system comprising:
a processor;
a data bus coupled to said processor; and
a computer-usable medium embodying computer code, said computer-usable medium being coupled to said data bus, said computer program code comprising instructions executable by said processor and configured for:
generating a status indicator with respect to at least one contact item associated with an electronic address book, in order to indicate an action applicable to at least one contact item; and
graphically displaying said status indicator with respect to a selection status of said contact item and in association with said at least one contact item, wherein said status indicator indicates an identification of said selection status of at least one intended e-mail recipient.

10. The system of claim 9 wherein said instructions are further configured for configuring said electronic address book with respect to an email editor wherein said electronic address book includes said at least one contact item from which said at least one intended email recipient is selected for emailing an attachment associated with said email editor.

11. The system of claim 9 wherein said instructions are further configured for configuring said status indicator to provide an option that identifies whether said at least one contact item was previously selected for an intended action.

12. The system of claim 9 wherein said at least one intended email recipient is selected from said electronic address book via at least one of the following actions: a “To:” action, a “Cc:” action, and a “Bcc:” action.

13. The system of claim 9 wherein said instructions are further configured for updating said action applicable to said at least one intended email recipient in association with an email address associated with said at least one contact item.

14. The system of claim 9 wherein said instructions are further configured for associating said status indicator with an electronic address book in a context of a scan-to-email functionality.

15. A computer usable medium for configuring a selection status for contacts, said computer usable medium embodying computer program code, said computer program code comprising computer executable instructions configured for:
generating a status indicator with respect to at least one contact item associated with an electronic address book in order to indicate an action applicable to at least one contact item; and
graphically displaying said status indicator with respect to a selection status of said contact item and in association with said at least one contact item, wherein said status indicator indicates an identification of said selection status of at least one intended e-mail recipient.

16. The computer usable medium of claim 15 wherein said embodied computer program code further comprises computer executable instructions configured for configuring said electronic address book with respect to an email editor wherein said electronic address book includes said at least one contact item from which said at least one intended email recipient is selected for emailing an attachment associated with said email editor.

17. The computer usable medium of claim 15 wherein said embodied computer program code further comprises computer executable instructions configured for configuring said status indicator to provide an option that identifies whether said at least one contact item was previously selected for an intended action.

18. The computer-usable medium of claim 15 wherein said at least one intended email recipient is selected from said electronic address book via at least one of the following actions: a “To:” action, a “Cc:” action, and a “Bcc:” action.

19. The computer usable medium of claim 15 wherein said embodied computer program code further comprises computer executable instructions configured for updating said action applicable to said at least one intended email recipient in association with an email address associated with said at least one contact item.

20. The computer usable medium of claim 15 wherein said embodied computer program code further comprises computer executable instructions configured for associating said status indicator with an electronic address book in a context of a scan-to-email functionality.
